(19) United States
(12) Patent Application Publication
(10) Pub. No.: US 2006/0045707 A1
(43) Pub. Date: Mar. 2, 2006

(54) Interchangeable multifunctional tow crossbar and accessories

(75) Inventors: Pablo Nolasco, Corona, NY (US); Harry Brown, Bay Shore, NY (US)

Correspondence Address: ALFRED M. WALKER, 225 OLD COUNTRY ROAD, MELVILLE, NY, 11747-2712, US

(73) Assignee: Autolift Technology Inc.

(21) Appl. No.: 11/145,212

(22) Filed: Jun. 4, 2005

Related U.S. Application Data
(63) Continuation-in-part of application No. 10/955,484, filed on Sep. 30, 2004, now abandoned.
(60) Provisional application No. 60/580,274, filed on Jun. 15, 2004.

(51) Int. Cl. B60P 3/12

(52) U.S. Cl. 414/563

(57) ABSTRACT

A wheel lift tow accessory device includes coupling knuckles which are pinned to the ends of the piston rods of two hydraulic cylinders, which are used to deploy and retract the rotatable arms of the wheel lift arm accessories. A plate of the wheel lift arm accessory has a recess to couple with a groove in the attachment knuckle. The plate is welded to the rotating subassembly of each of the two wheel lift arm accessories. A rotary cam pin lock is securely welded to the same subassembly and positioned in registration with the open end of the recess is used to lock the knuckle securely in place or to permit its withdrawal from the recess when detaching each removable wheel lift arm.

### RELATED APPLICATIONS

This application is a continuation-in-part of application Ser. No. 10/955,484, filed on Sep. 30, 2004, which is based in part upon provisional patent application Ser. No. 60/580,274, filed Jun. 15, 2004, and claims benefit under 35 USC 119(e) therefrom.

### FIELD OF THE INVENTION

The present invention relates to interchangeable, multifunctional tow crossbars for tow trucks.

### BACKGROUND OF THE INVENTION

Hydraulically operated wheel lift arms are described in U.S. Pat. No. 6,139,250 of Nolasco for lifting medium weight vehicles, such as automobiles. Heavier vehicles are towed by hooks and axle forks.

### OBJECTS OF THE INVENTION

It is therefore an object of the present invention to provide interchangeable, multifunctional tow crossbars for tow trucks with structurally sound temporary connections for rotatable wheel lift arms, hooks or axle forks.

### SUMMARY OF THE INVENTION

The present invention is directed to a multifunctional tow crossbar with interchangeable components, allowing a tow truck to use a variety of towing accessories as need be under the circumstances.

Existing tow crossbars are each attached to the outer distal end of a telescoping probe arm. A typical tow crossbar is located perpendicular to the probe arm.

In the present invention, the tow crossbar is modified to accommodate the interchangeable towing accessories. For example, the tow crossbar of the present invention contains two integral hydraulic cylinders, which are removably attached to a pair of interchangeable rotatable wheel lift arm scoop claws.

Removable and interchangeable accessories are provided which include the rotatable hydraulic wheel lift arm claws, chain (or cable) and sling, axle forks, and grab hook adapters and chains to tow very damaged vehicles. The axle forks and grab hook adapters and chain can be used with or without the chain and sling to protect the vehicle being towed as needed. All accessories can be attached or removed by a single worker. The accessories are compact and easy to store.

Only the rotatable wheel lift arms require the use of the hydraulic cylinders built into the tow crossbar. For the other towing accessories, the two hydraulic cylinders swing slightly away from the tow crossbar at their respective outer distal ends, to create space for attachment. Manually operated spring pins insure securement of the removable wheel lifts to the tow crossbar. The wheel lift arm accessory includes two separate components, left and right. Each has a single fixed claw and one claw which rotates by hydraulic power from a retracted position, to a deployed position, which engages a vehicle wheel.

Since inadvertent swinging of the rotatable wheel lift arm claw during attachment or detachment can be a safety hazard, a sleeve with a spring loaded ball is installed in the insert shaft of the removable wheel lift arm claw component. The ball is urged and engages a depression in the bracket of the rotating wheel lift arm claw, thereby locking it in the deployed position, so that it can be carried manually without slippage before or after use. Once the hydraulic cylinder is attached, it has no problem overpowering this safety latch.

The chain and sling is simply attached by engaging an attachment ring in the rigid bar at the top to the snap hook attached to the end of the winch-operated chain or steel cable. The latter is suspended from the upper chain boom of the tow truck. The lower loop of each wide rubberized or fabric sling section is simply engaged with the left and right ends of the tow crossbar.

The axle forks are weldments which include a fork welded to a short section of square crossection steel tubing. The latter is sized to slide over one end of the tow crossbar.

The grab hooks are welded to the end of a short piece of square crossection steel tubing sized to fit inside the open end of the tow crossbar. Optionally, they are locked in place within the tow crossbar with a spring pin.

In the preferred embodiment, specially designed attachment knuckles are permanently pinned to the ends of the piston rods of the two hydraulic cylinders, which are used to deploy and retract the rotatable arms of the wheel lift apparatus.

This completely eliminates the use of straight drop pins or bolts in the attachment of the rotatable arms of this invention. Drop pins or bolts are easily lost and damaged.

In the preferred embodiment, a plate with a recess to couple with a groove in the attachment knuckle is welded to the rotating subassembly of each of the two wheel lift arms. A rotary pin lock, which is securely welded to the same subassembly and positioned in registration with the open end of the recess, is used to lock the coupling knuckle securely in place, or to permit its withdrawal from the recess when detaching each wheel lift removable arm.

In this preferred embodiment, attachment coupling knuckles are used with the interchangeable multifunctional tow crossbar of a tow truck. This tow crossbar typically is attached transversely to the rearward telescoping arm extending from a rear of the tow truck. The tow crossbar is mounted on the outer distal end of the telescoping arm. While the pair of hydraulic cylinders are each connected at their respective proximal ends to the tow crossbar, the knuckles are used to attach each piston rod at an opposite, distal ends of each of the hydraulic cylinders to wheel lift arms.

Preferably, each hydraulic cylinder is pivotally attached to the tow crossbar, so that the hydraulic cylinders can be swung out of the way, when the piston rods are unattached to the wheel lift arms. Preferably, each optional cylindrical knuckle is removably mounted on a free end of each of the piston rods.

Each coupling knuckle has a first end engaging the free end of a hydraulic cylinder piston rod and a second end engaging a wheel lift arm. The first end of the coupling knuckle has a socket to receive the free end of the piston rod, and a socket wall surrounding the socket. The socket wall includes transversely aligned openings to receive a pin for engagement with the piston rod. Likewise, the piston rod has transverse opening through which the knuckle pin passes.

A slot in the knuckle socket wall extends from the first end of the coupling knuckle, to allow the coupling knuckle to pivot around the pin, up to 90 degrees with respect to the piston rod. An annular groove in the coupling knuckle is adjacent to the second end of the coupling knuckle, leaving a shoulder between the second end and the annular groove. The annular groove accommodates the wheel lift arm.

The wheel lift arm preferably has a plate, with a recess, to receive a shoulder of the coupling knuckle. A rotatable lock pin attached to the wheel lift arm plate has a handle for rotating a cam which positions the lock pin linearly between retracted and locking positions. The rotatable lock pin member, operated by rotational movement of the handle, moves the locking pin linearly between the retracted and locking positions, with respect to the annular groove of the coupling knuckle. This allows the coupling knuckle to be placed into engagement with the recess of the plate of the wheel lift arm. The locking pin of the lock pin member, which has an upward locking position extending into the annular groove of the coupling knuckle, locking the coupling knuckle into engagement with the wheel lift arm, which has the lock pin member attached thereto. The movable retractable locking pin is moved in and out of engagement position with the annular groove of the coupling knuckle by the locking cam handle, which rotates the locking pin between retracted and locking positions.

The coupling knuckle therefore provides releasable engagement between first and second towing accessory members, namely, each hydraulic cylinder and each respective removable wheel lift arm. It is preferably cylindrical in shape, and has a first end for engagement with a free end of the piston rod portion of the first towing accessory, such as the hydraulic cylinder, and a second end for engagement with the second member, which may be the removable wheel lift arm.

The first end of the coupling knuckle has a socket to receive the free end of the first member, such as the piston rod of the hydraulic cylinder, and a socket wall surrounding the socket. The socket wall has transversely aligned openings to receive the locking pin for engagement with the rod shaped portion of the first tow accessory member, such as the hydraulic cylinder, which has a transverse opening through which the locking pin passes.

A slot in the socket wall extends from the first end of the knuckle, to allow the knuckle to pivot around the locking pin up to 90 degrees, with respect to the rod shaped portion.

The annular groove in the coupling knuckle is located adjacent to the second end of the coupling knuckle, leaving a shoulder between the second end and, the annular groove for engagement with the second member, such as a plate of the wheel lift arm assembly.

The plate of the wheel lift arm has the recess to receive the shoulder of the coupling knuckle and to receive the rotatable lock pin of the cam-operable lock pin member, for rotational movement between a retracted position, allowing the coupling knuckle to be placed into engagement with the lift arm plate recess. Additionally, the locking pin extends into the annular groove of the coupling knuckle, locking the coupling knuckle into engagement with the second member, such as the wheel lift arm.

The tow crossbar of the tow truck is multifunctional. For example, when the coupling knuckle is released, instead of the removable wheel lift arm assembly, the tow crossbar towing accessory may also be the aforementioned axle fork assembly or chain grab hook adapter.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a perspective rear view of a tow truck equipped with the tow crossbar and rotatable wheel lifts of this invention;

FIG. 2 is a reverse perspective view of the tow crossbar showing hydraulic cylinders;

FIG. 3 is a perspective view of two rotatable wheel lift arms prior to attachment;

FIG. 4 is a perspective view of the tow crossbar with attached wheel lift arms showing one in a deployed position and the other in a retracted position;

FIG. 5 is a perspective view of the driver's position while removing or installing a rotatable wheel arm;

FIG. 5a is a side crossection of a ball spring plunger in a safety latch depression in a rotatable plate, taken along view lines “5a-5a” of FIG. 5;

FIG. 6 is a perspective view of a chain and sling accessory attached to a tow crossbar and a chain or cable;

FIG. 7 is an exploded perspective view of the axle fork components adjacent the tow crossbar;

FIG. 7a is a close-up detail view of the installed axle fork component;

FIG. 8 is an exploded perspective view of the grab hook inserts adjacent the tow crossbar installation within end of tow crossbar;

FIG. 8a is a reverse perspective view of an installed grab hook insert, secured to the tow crossbar via the spring pin, taken along the dashed line “8a” of FIG. 8;

FIG. 9 is a perspective assembly view of the attachment knuckle of the preferred embodiment and its attachment to the end of a piston rod;

FIG. 9a is a perspective view of the attachment knuckle shown at a 90 degree angle to the piston rod;

FIG. 10 is a reverse perspective view of the tow crossbar showing both hydraulic cylinders with coupling knuckles at the distal ends of their piston rods;

FIG. 11 is a perspective view of a detail of the rotating subassembly of a wheel lift arm of the preferred embodiment during insertion into the crossbar;

FIG. 12 is an enlarged reverse perspective detail view of the welded plate with a coupling recess that is part of the rotating wheel lift subassembly of FIG. 11; and,

FIG. 13 is a side perspective detail showing the pin of a rotary pin lock engaging the coupling knuckle thereby locking it to the rotating subassembly.

### DETAILED DESCRIPTION OF THE INVENTION

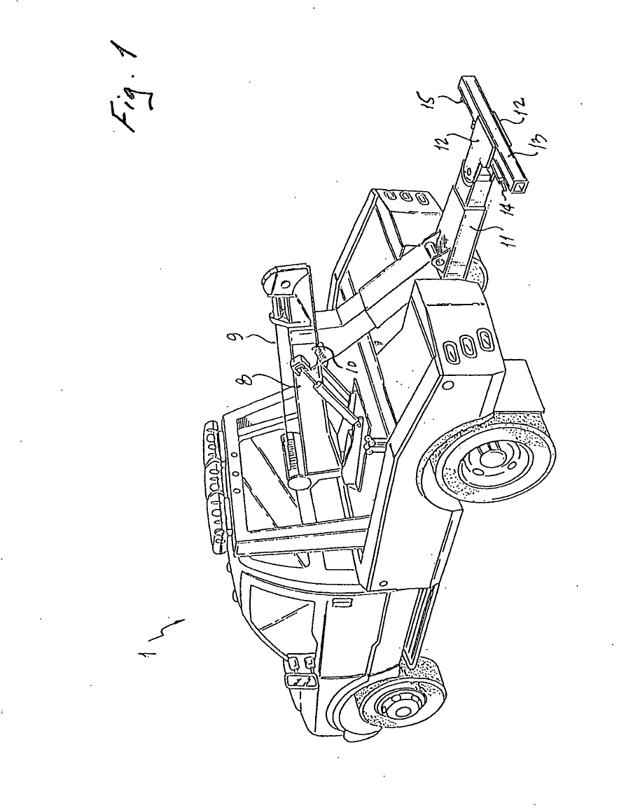

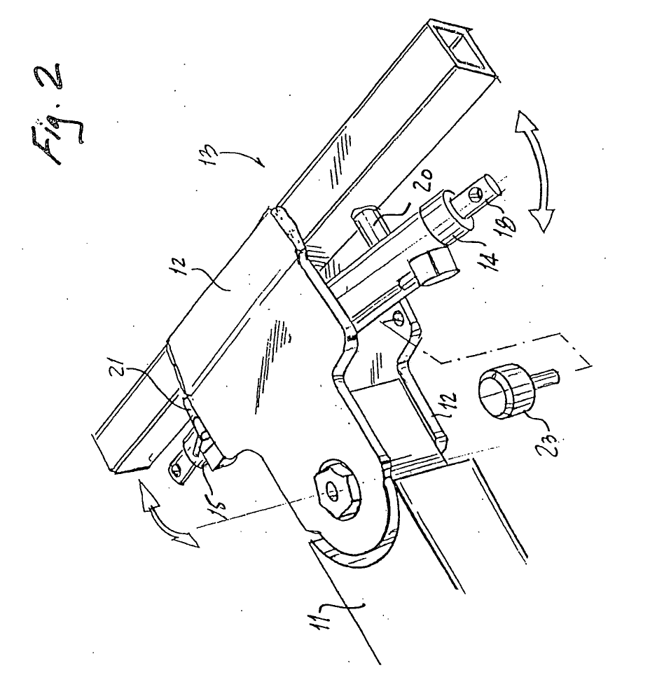

FIG. 1 shows a tow truck 1 equipped with a tow crossbar 13 of this invention. Truck 1 has an upper cable boom 8, cable and snap hook 10. Top and bottom plates 12 attach tow crossbar 13 to telescoping lower arm 11. Hydraulic cylinders 14 and 15 are visible.

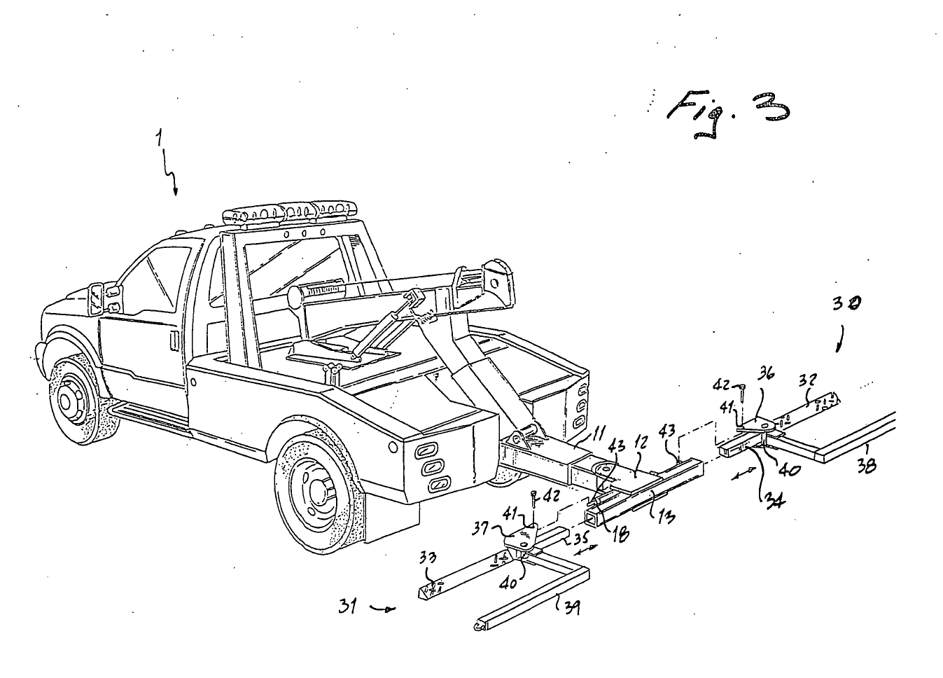

FIG. 2 is a reverse perspective view of tow crossbar 13. Hydraulic cylinder 14 with piston rod 18 is pivotally mounted between plates 12. Stop pin 23 is mounted to lower plate 12, and prevents cylinder 14 from unwanted movement adjacent to tow crossbar 13. Manually operated spring pins 20 and 21 are shown installed on tow crossbar 13, below and above cylinders 14 and 15 respectively. These pins serve to secure towing accessories during installation with tow crossbar 13. Spring pins are manually retracted to allow removal of towing accessories.

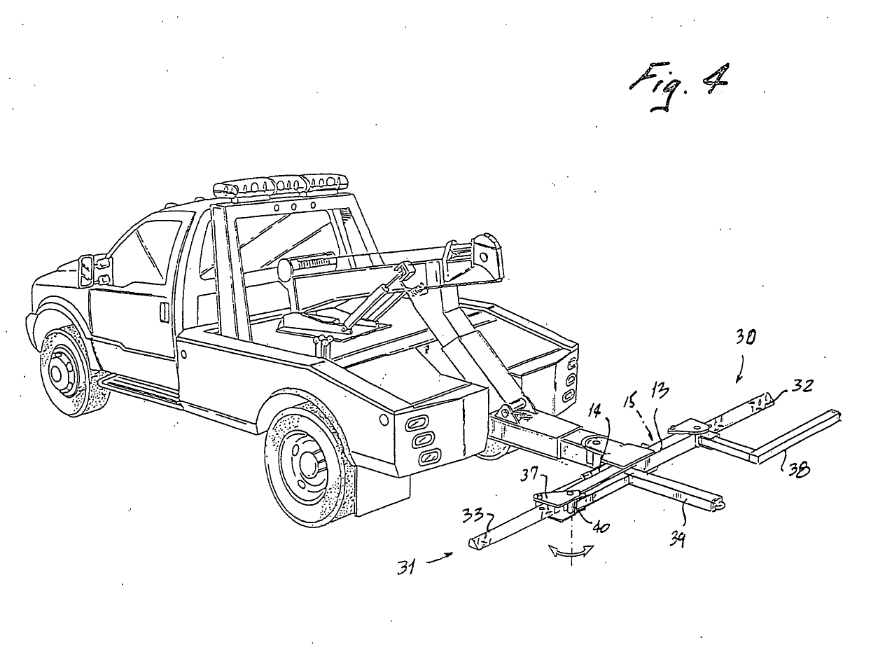

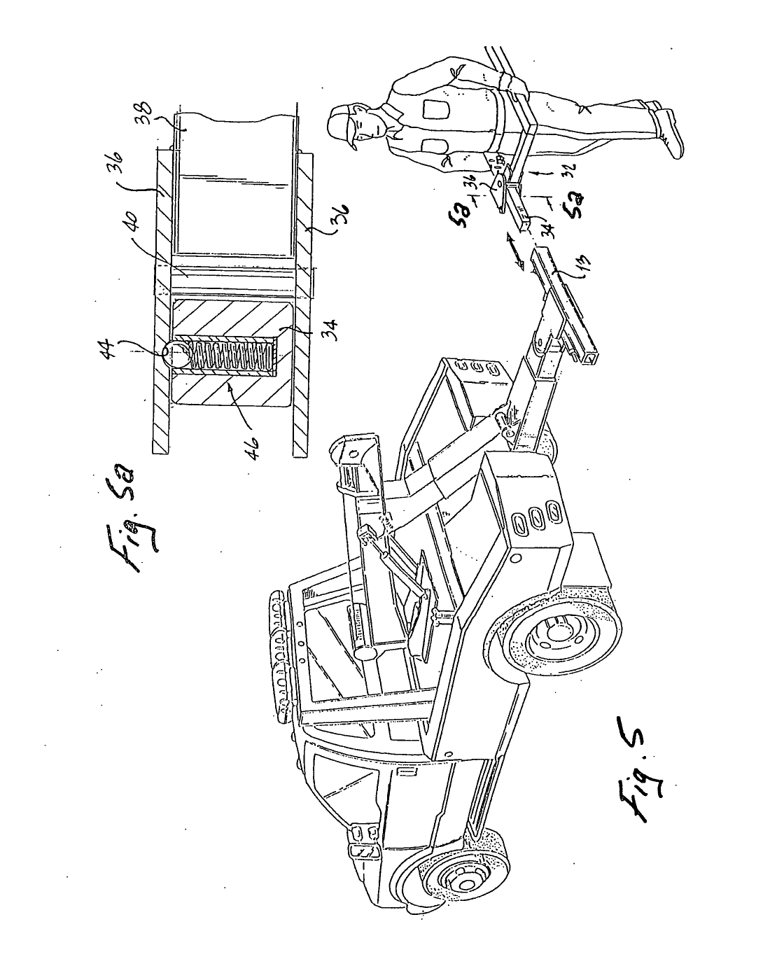

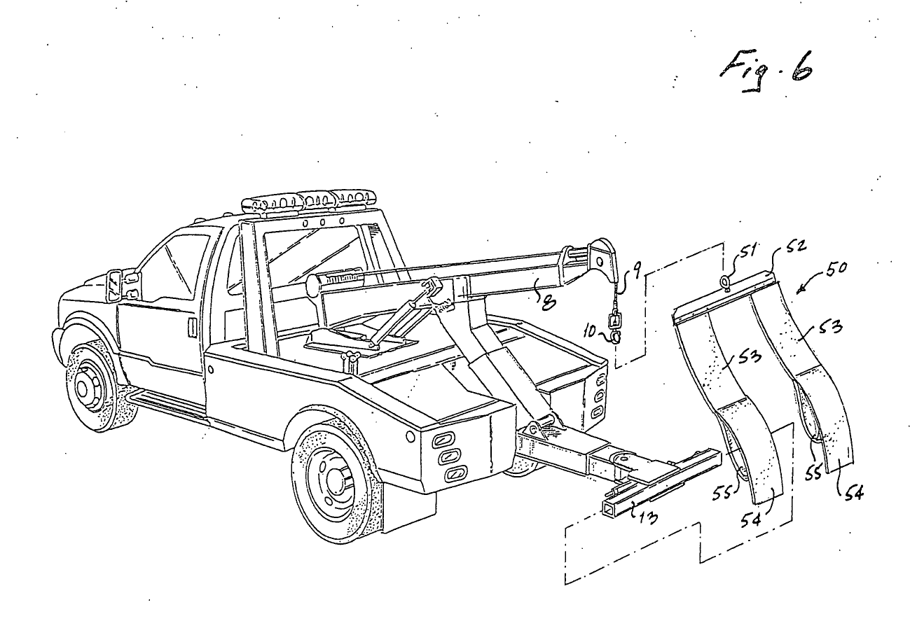

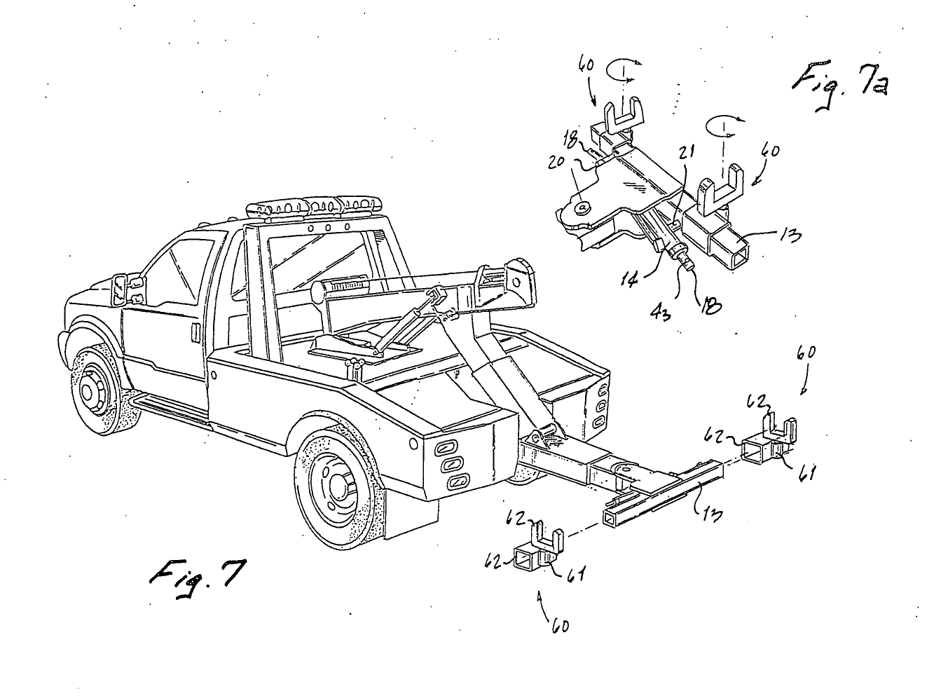

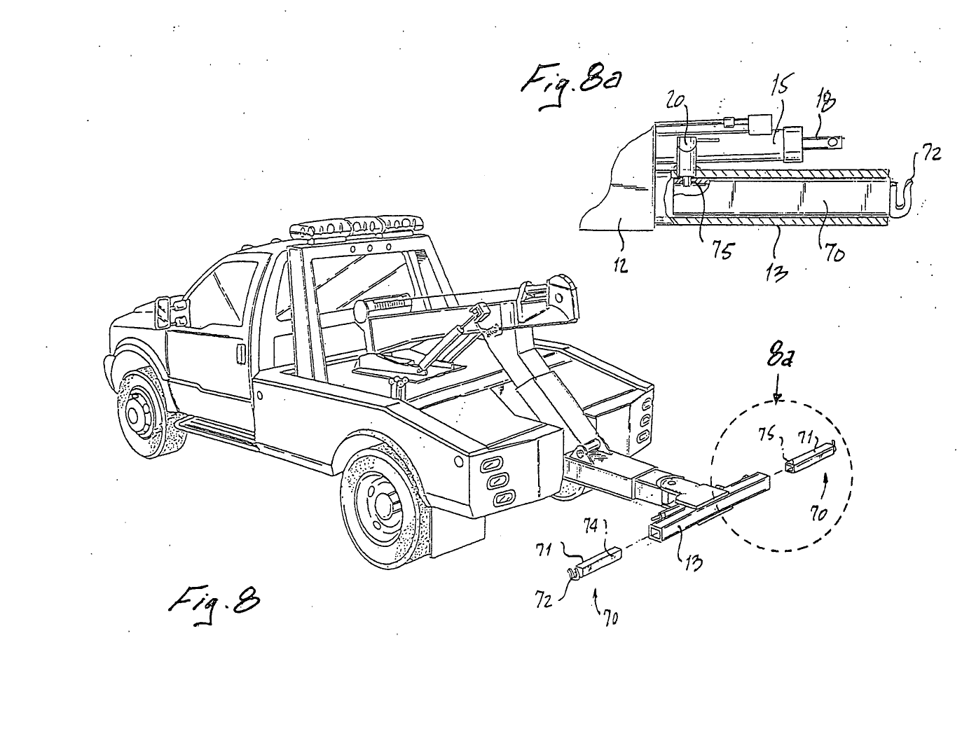

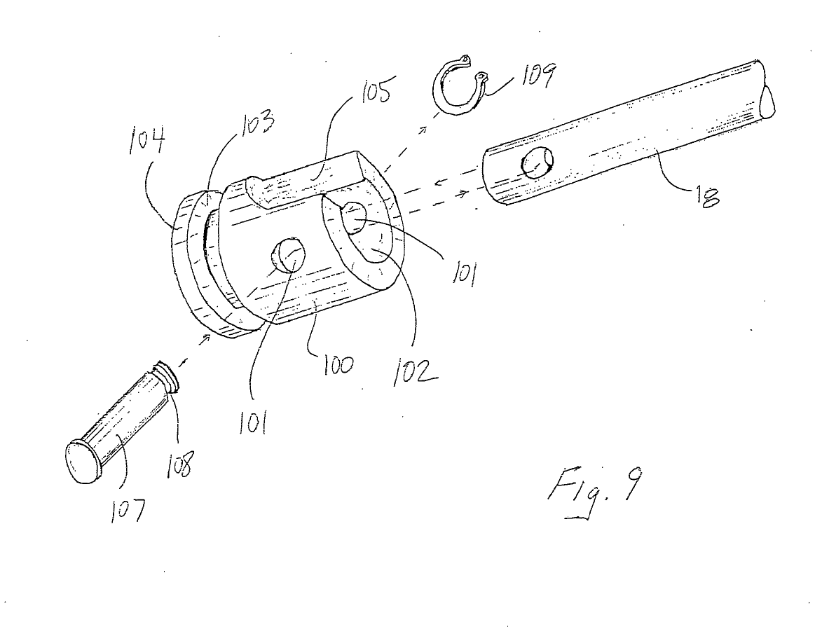

FIG. 3 shows right wheel lift assembly 30 and left wheel lift assembly 31 prior to attachment to tow crossbar 13. Although only top rotatable plates 36 and 37 are shown, it is understood that identical plates underneath complete the mechanisms. Fixed wheel lift arm claws 32 and 33 are rigidly attached to insertion members 34 and 35 respectively which are to be inserted into the ends of tow crossbar 13. Pivot pins 40 are also attached to these fixed members and plates 36 and 37 are free to rotate about pins 40. Rotatable wheel lift arm claws 38 and 39 are rigidly attached to plates 36 and 37 respectively. Holes 41 accept pins 42, which pass through bores 43 on piston rods 18.

FIG. 4 shows wheel lifts attached to tow crossbar 13. Hydraulic cylinder 14 is extended in this view forcing claw 39 into the retracted position. Cylinder 15 is retracted thereby forcing claw 38 into the deployed position in this view.

FIG. 5a is a crossection detail showing ball spring plunger 46 engaging depression 44 in top plate 36 or 37, to effect safety latching in the deployed position, even with hydraulic cylinder 14 or 15 detached. This is a safety measure for workers, who have to manipulate either wheel lift assembly 30 or 31 when dislodging it from tow crossbar 13, and then storing it on the deck of the truck, as seen in FIG. 5. The deck of the truck can be modified with recesses or pockets (not shown) for storage of the accessories.

FIG. 6 shows a perspective detailed view of the portable sling accessory 50. Top bar 52 is lifted via loop 51 engaged within snap hook 10 to cable 9 which is guided by cable boom 8. Rubberized, fabric or leather straps 53 with distal flaps 54 protect the vehicle being towed. Loops 55 are installed over the outermost ends of tow crossbar 13. This is made possible by swinging hydraulic cylinders away from tow crossbar 13.

FIGS. 7 and 7a shows a detail of axle fork assemblies 60, which includes removable axle fork 62, which is fitted to tube 61. Tube 61 is welded to tubing collar of axle fork assembly 60, sized to slip over tow crossbar 13.

FIG. 8a is a perspective detail of chain grab hook adapter assembly 70 including short tubing section 71 welded to grab hook 72. Tubing 71 fits inside distal end of tow crossbar 13 and is locked in place via spring pins 20 and 21 through holes 74 and 75.

In the foregoing description certain accessories 30, 31 or 70 are shown inserted within the distal ends of the tow crossbar 13 and certain accessories 50 or 60 are shown surrounding the tow crossbar 13 in a cradle configuration.

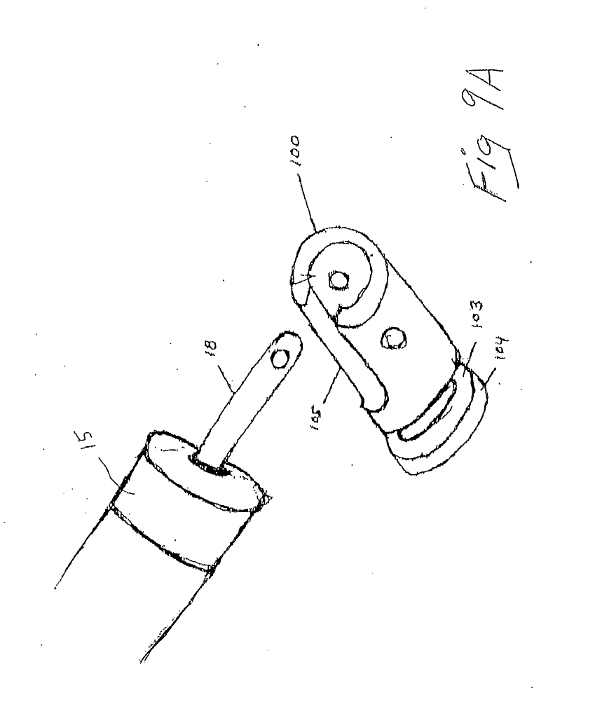

In an effort to eliminate the use of drop pins or bolts and to create a more secure and ergonomic coupling for the wheel lift arms of this invention, coupling knuckles 100, as shown in FIGS. 9 and 9a, are pinned to piston rods 18 via the hole near the distal end of rods 18. Rod 18 is inserted through the axial blind hole at the back end of coupling knuckle 100. Then pin 107 with distal groove 108 is inserted through transverse holes 101 thereby engaging rod 18. C-shaped lockring 109 is then inserted into groove 108, thereby retaining the subassembly.

In FIG. 9, the attachment knuckle 100 is shown axially aligned with respect to the end of a piston rod 18. In contrast, in FIG. 9a the attachment knuckle 100 shown at a 90 degree angle to the piston rod 18.

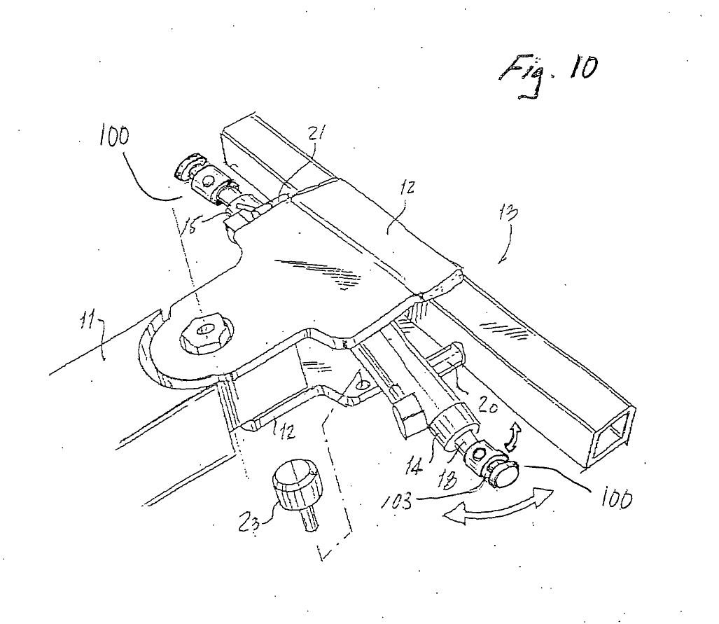

As shown in FIGS. 9, 9a and 10, coupling knuckle 100 can rotate a full 90 degrees clockwise by virtue of slot 105 giving access to pivotable movement of rod 18 within slot 105. Coupling knuckle 100 also has engaging annular groove 103 as defined by spaced apart distal flange part 104. Coupling knuckles 100 are shown assembled to hydraulic cylinders 14 and 15 in FIG. 10.

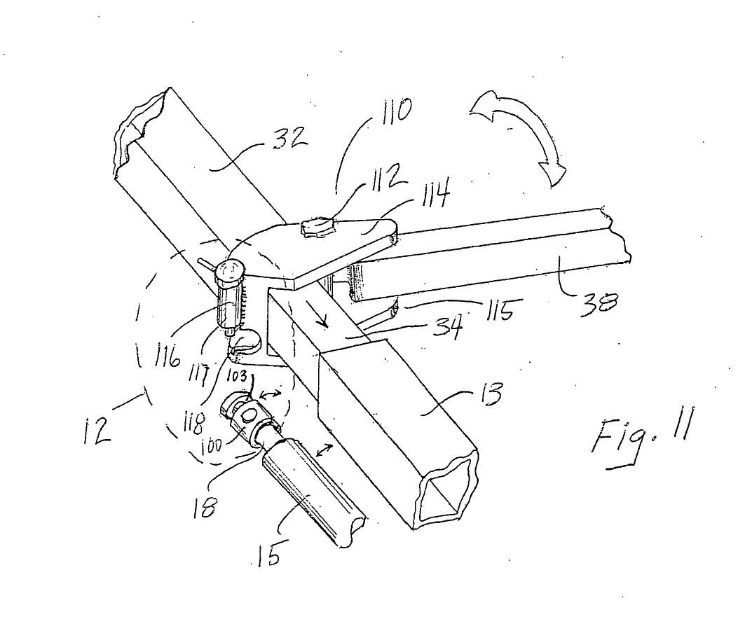

FIG. 11 is a close-up detail view of rotating subassembly 110 of one of the two wheel lift arms, as coupling bar 34 is being inserted into tow crossbar 13. The relative position of hydraulic cylinder 15 is also shown for reference. Welded structure top plate 114, bottom plate 115, and rotating wheel lift arm 38 pivot around axle pin 112 welded to fixed wheel lift part 32. Plate 116 is welded to both top and bottom plates 114 and 115 respectively. Rotary pin lock 117 is poised above coupling recess 118 sized to accept the root diameter inside annular groove 103 of coupling knuckle 100.

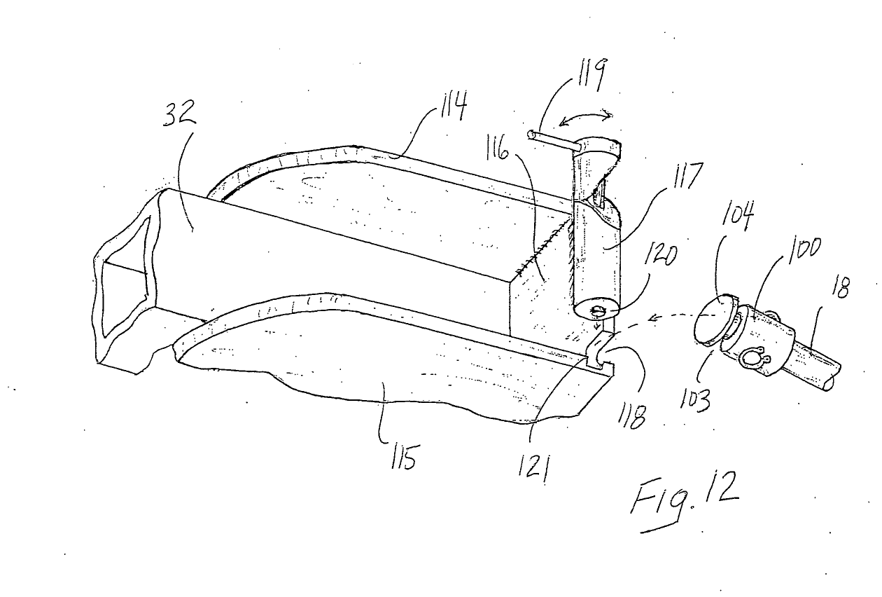

Rear perspective view FIG. 12 shows rotary pin lock 117 with handle 119 rotated to retract pin 120 from its bottom surface. Groove 121 in bottom plate 115 gives access to flange 104 of coupling knuckle 100.

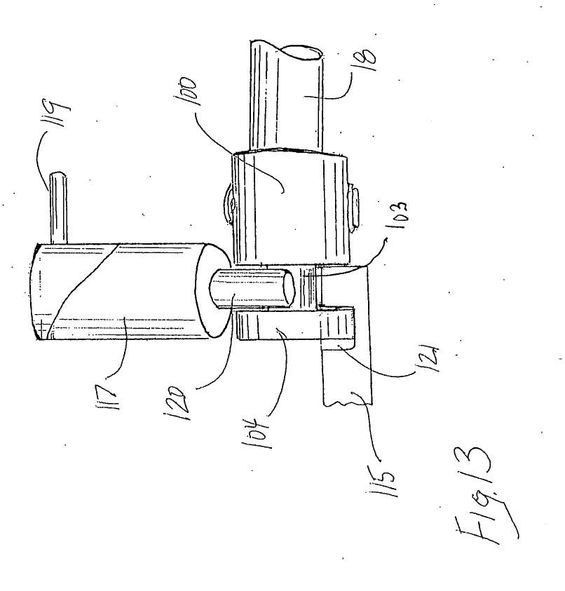

Although plate 116 with recess 118 is obscured by pin 20 and knuckle groove 103 in this view, the extreme close-up detail view of FIG. 13 shows coupling knuckle 100 inserted in recess 118 and locked in place with pin 120 extended from rotary pin lock 117 (shown in a rotated position of handle 119). Coupling knuckle 100 groove 103 has over 180 degrees contact with plate 116 and bottom plate 115 groove 121.

Although only one side of the preferred embodiment is detailed in these last FIGS. 12 and 13, the side not shown functions in the same manner. The only changes involve the position of recess 118 that is adjacent to the top plate, instead of the bottom plate, to match the vertical position of hydraulic cylinder 14 which is higher than cylinder 15. The rotary lock pin is attached closer to the bottom plate and its operating handle is at the bottom with the pin extending from its top surface.

The articulation of coupling knuckle 100 on pin 107 replaces the freedom of motion formerly afforded by straight drop pins 42 as shown in FIG. 3 of a different embodiment. Groove 105 is necessary to avoid interference by piston rod 118, during the motion required during deployment or retraction of the rotatable wheel lift arms 32 or 33.

It is noted however, the fact that whether the accessory is inserted internally within, or externally over, the outer opposite distal ends of the tow crossbar is not to be limiting, as those skilled in the art can provide connections to the tow crossbar 13, regardless of whether the connections are internal or external to the distal ends of the tow crossbar 13.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention.

We claim:

1. An interchangeable multifunctional tow crossbar for use with a tow truck comprising:
a telescoping arm extending from a rear of said tow truck having a free, distal end;
a tow crossbar mounted on said distal end of said telescoping arm;
a pair of hydraulic cylinders each connected at a proximal end to said tow crossbar, opposite, distal ends of said hydraulic cylinders having piston rods extending therefrom for attachment to lifting accessories, each hydraulic cylinder being pivotally attached to said tow crossbar so that said hydraulic cylinders can be swung out of the way when said piston rods are unattached to any accessory;
a cylindrical coupling knuckle removably mounted on a free end of each of said piston rods;
each coupling knuckle having a first end in engagement with the free end of a piston rod and a second end for engagement with a lifting accessory;
the first end of said coupling knuckle having a socket to receive the free end of the piston rod, a socket wall surrounding said socket, said socket wall having transversely aligned openings to receive a pin for engagement with said piston rod, said piston rod having transverse opening through which said pin passes;
a slot in said socket wall extending from said first end of said knuckle to allow said knuckle to pivot around said pin up to 90 degrees with respect to said piston rod; and
an annular groove in said knuckle adjacent the second end of said knuckle, leaving a shoulder between said second end and said annular groove for engagement with an accessory.

2. The interchangeable multifunctional tow crossbar of claim 1 in which said accessory has a recess to receive said shoulder of said knuckle and a rotatable lock pin operated by rotational movement between a retracted position, allowing said knuckle to be placed into engagement with said recess and a locking position extending into said annular groove of said knuckle locking said knuckle into engagement with said accessory.

3. The interchangeable multifunctional tow crossbar of claim 2 in which said lock pin has a handle for rotating said lock pin between retracted and locking positions.

4. The interchangeable multifunctional tow crossbar of claim 3 in which said accessory is an axle fork assembly.

5. The interchangeable multifunctional tow crossbar of claim 3 in which said accessory is a chain grab hook adapter.

6. The interchangeable multifunctional tow crossbar of claim 3 in which said accessory is a lift claw assembly.

7. A coupling knuckle for providing releasable engagement between first and second members comprising:
said coupling knuckle being cylindrical in shape and having a first end for engagement with a free end of a rod shaped portion of said first member and a second end for engagement with said second member;
the first end of said coupling knuckle having a socket to receive the free end of the first member, a socket wall surrounding said socket, said socket wall having transversely aligned openings to receive a pin for engagement with said rod shaped portion of said first member, said rod shaped portion having a transverse opening through which said pin passes;
a slot in said socket wall extending from said first end of said coupling knuckle to allow said coupling knuckle to pivot around said pin up to 90 degrees with respect to said rod shaped portion; and
an annular groove in said coupling knuckle adjacent the second end of said coupling knuckle leaving a shoulder between said second end and said annular groove for engagement with said second member.

8. The coupling knuckle of claim 7 in which said second member has a recess to receive said shoulder of said coupling knuckle and a rotatable lock pin operated by rotational movement between a retracted position allowing said coupling knuckle to be placed into engagement with said recess and a locking position extending into said annular groove of said coupling knuckle locking said coupling knuckle into engagement with said second member.

9. The coupling knuckle of claim 8 in which said lock pin has a handle for rotating said lock pin between retracted and locking positions.
